(19) United States
(12) Patent Application Publication
(10) Pub. No.: US 2011/0138639 A1
(43) Pub. Date: Jun. 16, 2011

(54) PHOTOLUMINESCENT OPTICAL SIGHTS AND DEVICES AND METHODS THEREFROM

(75) Inventors: Edward Kingsley, Stow, MA (US); Gerard Gomes, West Boylston, MA (US); Robert Winskowicz, North Andover, MA (US)

(73) Assignee: PERFORMANCE INDICATOR LLC

(21) Appl. No.: 12/482,311

(22) Filed: Jun. 10, 2009

(51) Int. Cl. G01C 15/00; B32B 5/00

(52) U.S. Cl. 33/228; 33/275 R; 428/375

(57) ABSTRACT

The present invention provides for photoluminescent optical fibers that are used to illuminate sighting reticles. The fibers are activated by electromagnetic radiation and emit electromagnetic radiation of various wavelengths at high intensity and for long periods of time. The emission from the photoluminescent fiber can only be seen coming from one terminal end of the fiber, which is designed to be positioned inside the sighting device to illuminate a reticle. The photoluminescent fiber contains a base optical fiber which is covered at least in part by a photoluminescent composition which itself is fully covered by a second composition that allows the activating electromagnetic radiation to pass through to activate the photoluminescent layer while preventing the emissive electromagnetic radiation of the photoluminescent layer from passing back through.

### FIELD OF THE INVENTION

The present invention relates to an optical sighting device which contains a photoluminescent optical fiber that is activated by ambient light and emits light to illuminate a sighting reticle allowing sighting during both day and night, the photoluminescent optical fiber containing an additional layer that prevents any light from being visible to an external observer, thus allowing covert sighting at nighttime.

### BACKGROUND OF THE INVENTION

Reflex optical sights are well know and are used in such applications as gun sights, distance finders and camera view finders. Such devices generally use reticle patterns to mark an area or object of interest. Light from the reticle is reflected back to the observer from a semi-transparent, semi-reflective mirror or lens surface, through which light from the object of interest also passes though. The reticle is superimposed onto the object image during the sighting operation to allow for proper targeting. All reticles need to be illuminated by light from a light source. Typically a battery powered LED or a tritium lamp is used to illuminate the reticle.

Recently reflex optical sights have been disclosed wherein a fiber optic light collector is used to collect ambient light and transfer the light to the reticle to illuminate it; see, for example, Bindon in U.S. Pat. No. 5,653,034. The fiber optic light collector utilizes pigmented fluorescent materials in the core of the fiber which function optimally under daytime conditions, as ambient light can readily be collected, but in low light or nighttime conditions the fluorescent materials do not provide any illuminations since once the activation source is removed, fluorescent materials stop emitting. This type of optic sighting device is deficient in low light conditions and can not be used for night time applications.

Modern optical sights use multiple power sources to illuminate reticles for aiding in sight alignment, including the aforementioned optical fibers, tritium lamps, and battery powered LED's and, further, chemiluminescent devices. This array of reticle illumination light sources allow for both daytime and nighttime sighting as well as redundant backup systems. For example, at night, should the batteries for the LED be discharged, a chemiluminescent light stick can be activated and inserted into the optical sight to allow the reticle to be illuminated. In these modern sights, an optical fiber is located on the surface of the sight allowing the optical fiber light to be exposed to ambient light conditions, such as the sun. It collects the light that is received from the ambient light sources and focuses it transversely or radially inward over the length of the fiber and the fiber transmits the light through to a second, non-photoluminescent, optical fiber that transmits the light into the device to illuminate the reticle and display the reticle pattern. During daylight, usage of the optical sight relies solely on ambient lighting conditions and the optical fiber light collector structure. As mentioned, at night or in low light conditions, the tritium lamp and/or the LED are required to be used to illuminate the reticle. The second fiber, mentioned above, is arranged such that light from the tritium lamp and/or the LED impinges on the second optical fiber and is carried by that fiber to illuminate the reticle. The second optical fiber, however, is not directional in that the light it captures from the LED or tritium lamp propagates outwardly towards the surface of the sight as well as inwardly toward the reticle. This results in visible light escaping from the surface of the sight at night or in low light conditions and allows the sighting device to be observable. However, these concepts, while enabling nighttime usage, suffer from the deficiency that the light will give away positions of the sight operator thereby putting the operator in jeopardy, particularly in combat situation.

Furthermore, LED's rely on batteries which are heavy and can make it difficult for the user to maintain sighting without getting fatigued. Batteries are bulky requiring the sighting device to be made bigger than it needs to be in order to use the batteries. Batteries are also temporary. Their energy drains even when not in use. Using the newer type of batteries can be prohibitively expensive. To adjust for battery lifetime, some sighting devices have incorporated chemiluminescent glow sticks into the sight. Again this requires accommodating space and the need to break the stick externally and place into the sight. It should be obvious that breaking the glow stick to allow the chemicals to mix and glow is performed in the open and will compromise the sight user's position.

One method employed to eliminate this problem is to provide an opaque rubber cap over the ambient light collection area where light from the optical fibers can be seen. During the day the cap is removed so that ambient light may be collected and allow the reticle to be illuminated. At night or in low light condition, the cap is replaced and alternative power sources are used; tritium lamps and LED's. While this fiber optic device is useful, it requires that the operator make a conscious decision to open or close the blocking cap. As would happen in the case of operator error, or if the operator was preoccupied, such as in the heat of battle, the cap may not be replaced, or may break off, and the operator's position may be compromised.

Nighttime usage can also be achieved without the use of tritium or LED's by using photoluminescent phosphorescent materials in the sighting fiber. This concept still suffers from the deficiency that the emission from the photoluminescent phosphorescent materials can still be seen emitting from the sighting fiber thus allowing detection of the position of the sighting device operator.

Optical fibers for sighting applications that containing pigments and fluorescent materials have also been described see U.S. Pat. No. 4,877,324 to Hauri, et al. The pigments and fluorescent materials in the fiber composition alter the light coming from an ambient collection, LEDs and/or tritium lamps to emit red, orange, yellow and amber light onto the reticle as well as reflecting light back to the user's lens. These fibers, again, can only collect light during the daytime when ambient light is available and are only used to carry light from LED's and tritium lamps during the nighttime. Opaque rubber caps are still necessary to cover stray light coming from the fiber due to the secondary light sources.

Fisher et al, in U.S. Pat. No. 5,359,800, describes an illuminated gun sight for day and night sighting which depends on radioluminescent materials, specifically tritium gas, to cause a phosphorescent material to glow. Use of radioactive tritium is not desirable, as described below. As well the site will glow continuously so the gun sight can be observable unless a cap or other covering device is employed. This again can be important in stealth situations wherein the position of the gun sight operator is to be kept unknown.

The tritium used in tritium lamps is a radioactive element of hydrogen. It decays to give a beta particle which is dangerous if ingested or inhaled. Thus, tritium is an undesirable material for use in sighting devices both for human health issues and environmental issues.

Thus there is a need for optical sights which give a desired reticle color both during the day and at nighttime without the use of toxic tritium or LED's while at the same time prevents an operator from being detected during nighttime usage.

### SUMMARY OF. THE INVENTION

The present invention provides for photoluminescent optical fibers used in optical sighting devices which illuminate a sighting reticle in both daytime and nighttime operations without the sighting device being observable. The fibers contain a base optical fiber that is used to carry light, covered at least in part by a first photoluminescent layer that is charged by ambient light and emits light during the daytime and at night, and further a second emission-blocking layer is applied which contains materials that allow ambient light to pass through and charge the photoluminescent layer but blocks any emissive radiation from coming back through and being seen. The photoluminescent layer contains high persistence phosphorescent materials and optionally contains selected fluorescent materials which combination provides for a final desired color. The base optical fiber may be clear or may contain fluorescent materials in its composition which will emit in a desired selected color when light from the photoluminescent layer excited it. When the base fiber contains fluorescent materials it may extend beyond the photoluminescent and second layers into the body of the sighting device wherein it can be activated by artificial, non-photoluminescent sources. The fluorescent materials can be chosen to give a desired color of the reticle, independent of the color of the artificial source.

One advantage of the present optical fiber and optical sighting device is that they can be used at night without the need for tritium which is toxic on LED's which require heavy batteries, which have limited lifetime. Emission from the sighting device can not be detected by an observer, thus, preserving the stealth position of the operator. The present optical fiber and optical sighting device can also be created so that a wide spectrum of reticle colors can be achieved.

In a first aspect, a photoluminescent optical fiber for illuminating a reticle in a sighting device for day and night sighting containing a base optical fiber, covered at least in part by a photoluminescent layer comprising one or more phosphorescent materials and optionally one or more fluorescent materials selected to provide a final desired color and a second layer covering the photoluminescent layer that contain materials that allow radiation that charges the underlying photoluminescent materials to pass through the second layer and block emission of the underlying photoluminescent materials from passing back through the second layer is provided.

In a second aspect, a photoluminescent optical fiber for illuminating a reticle in a sighting device for day and night sighting containing a base optical fiber containing fluorescent materials chosen to provide a final desired color, covered at least in part by a photoluminescent layer comprising phosphorescent materials and a second layer covering the photoluminescent layer that contains materials that allow radiation that charges the underlying photoluminescent materials to pass through the second layer and block emission of the underlying photoluminescent materials from passing back through the second layer is provided.

In a third aspect, a photoluminescent optical fiber for illuminating a reticle in a sighting device for day and night sighting containing a base optical fiber containing fluorescent materials chosen to provide a final desired color, covered at least in part by a photoluminescent layer comprising phosphorescent materials and a second layer covering the photoluminescent layer that contains materials that allow radiation that charges the underlying photoluminescent materials to pass through the second layer and block emission of the underlying photoluminescent materials from passing back through the second layer wherein the base fiber extends beyond the photoluminescent and second layers into the body of the sighting device wherein it can be activated by artificial, non-photoluminescent sources is provided.

In a fourth aspect, a sighting device containing a photoluminescent optical fiber of the aforementioned photoluminescent optical fibers is provided.

In a fifth aspect, a sighting device containing a photoluminescent optical fiber of the aforementioned photoluminescent optical fibers that contains a holding mechanism is provided.

In a sixth aspect, a method of covertly sighting an object utilizing the photoluminescent optical fibers and devices of the aforementioned aspects is provided.

### BRIEF DESCRIPTIONS OF DRAWINGS

FIG. 1 is a cross-section of the photoluminescent optical fiber. An optical fiber [10] is coated with a photoluminescent layer [12]. A second layer [14] that contains materials that allow radiation that charges the underlying photoluminescent materials in [12] to pass through the second layer [14] and block emission of the underlying photoluminescent materials in [12] from passing back through the second layer [14] is coated all the way around the fiber.

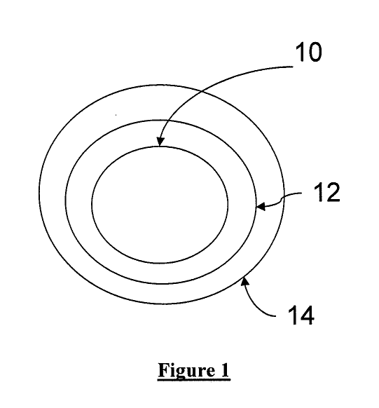

FIG. 2 is a cross-section of the photoluminescent optical fiber embedded in a holder for an optical sight device. An optical fiber [10] is place into a holder which is either a stand alone holder or body of the optical sighting device [16]. The fiber [10] is cover with a photoluminescent layer [12]. In this case the layer [12] only covers the portion of the fiber into which it is capable of emitting photoluminescence. A second layer [14] that contains materials that allow radiation that charges the underlying photoluminescent materials in [12] to pass through the second layer [14] and block emission of the underlying photoluminescent materials in [12] from passing back through the second layer [14] is coated on top of the photoluminescent layer [12]. In this case the second layer [14] only covers the portion of the photoluminescent layer [12] that is capable of emitting radiation that can be seen by an external observer. The structure of [14] may be rectangular as depicted in FIG. 2 or it could be of any structure whose thickness is enough to allow radiation that charges the underlying photoluminescent materials in [12] to pass through the second layer [14] and block emission of the underlying photoluminescent materials in [12] from passing back through the second layer [14] is coated all the way around the fiber.

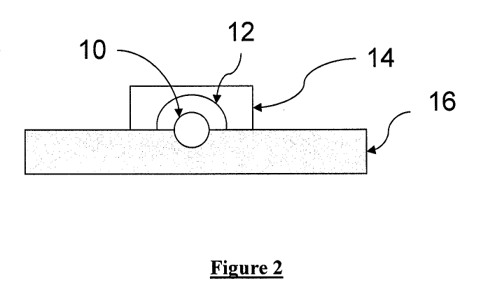

### DETAILED DESCRIPTION OF THE INVENTION

As used herein, a “luminescent” material is a material capable of emitting electromagnetic radiation after being excited into an excited state.

As used herein, a “photoluminescent composition” is defined as an admixture of materials which is capable of emitting electromagnetic radiation from electronically-excited states when excited or charged or activated by electromagnetic radiation.

As used herein, a “fluorescent” material is a material that has the ability to be excited by electromagnetic radiation into an excited state and which releases energy in the form of electromagnetic radiation rapidly, after excitation. Emissions from fluorescent materials have no persistence, that is, emission essentially ceases after an excitation source is removed. The released energy may be in the form of UV, visible or infrared radiation.

As used herein, a “phosphorescent” material is a material that has the ability to be excited by electromagnetic radiation into an excited state, but the stored energy is released gradually. Emissions from phosphorescent materials have persistence, that is, emissions from such materials can last for seconds, minutes or even hours after the excitation source is removed. The released energy may be in the form of UV, visible or infrared radiation.

“Luminescence”, “phosphorescence” or “fluorescence” is the actual release of electromagnetic radiation from a luminescent, phosphorescent or fluorescent material, respectively.

As used herein “Luminous Intensity” is defined as a measure of emitted electromagnetic radiation as perceived by a “standard observer” (see e.g. C. J. Bartelson and F. Grum, Optical Radiation Measurements, Volume 5—Visual Measurements (1984), incorporated herein by reference) as mimicked by a photoptic detector, such as an IL 1700 Radiometer/Photometer with high gain luminance detector by International Light Co of Massachusetts.

As used herein, an “optical fiber” refers to a fiber well known in the art that is made from silicon-based or organic-based polymer-based materials or a combination thereof used to carry light through to a terminus.

As used herein, a “photoluminescent optical fiber” refers to an optical fiber as defined above that has been at least partially coated with a photoluminescent layer.

As used herein, a “photoluminescent layer” refers to a layer containing selected materials that luminesce when electromagnetic energy is applied to the layer.

As used herein, a “sighting device” refers to any device that is use to obtain a sight line, including, for example, a gun sight, a camera sight, a distance finding sight, binoculars and telescopes.

As used herein “CAS #” is a unique numerical identifier assigned to every chemical compound, polymer, biological sequences, mixtures and alloys registered in the Chemical Abstracts Service (CAS), a division of the American Chemical Society.

The present invention relates to photoluminescent optical fibers that are used to illuminate sighting reticles. The fibers are activated by electromagnetic radiation and, depending on the composition, emit electromagnetic radiation of various wavelengths at high intensity and for long periods of time. The emission from the photoluminescent fiber can only be seen coming from one terminal end of the fiber, which is designed to be positioned inside the sighting device to illuminate a reticle. The photoluminescent fiber contains a base optical fiber which is covered at least in part by a photoluminescent composition which itself is fully covered by a second composition that allows the activating electromagnetic radiation to pass through to activate the photoluminescent layer while preventing the emissive electromagnetic radiation of the photoluminescent layer from passing back through.

The base optical fibers useful in the current invention include, for example, fibers made from various silicon dioxide compositions that are typically used in glass optical fibers, fibers made from optical polymers such as, for example, polymethyl methacrylate or polystyrene, organo-silicon materials or other organic or inorganic materials whose refractive index is conductive to transmitting optical radiation of particular wavelengths and which are useful as optical fibers. These materials are well known in the art. The fiber may be a single strand or be composed of an inner core and an outer clad, differing in refractive index, typical of standard optical fibers. Light entering the base optical fiber at an angle will reflect internally in the fiber back and forth until it reaches a terminal end and exits the fiber, for example, to illuminate a sighting reticle. Due to the relatively short distances of a sighting device sufficient light reaches the terminal end of the fiber. In some instances the base fiber may be of a core-clad construction such that the clad is lower in refractive index than the core allowing for more efficient light transmission.

The base optical fibers may be clear and colorless or optionally they may contain fluorescent materials. The base optical fiber is covered at least in part by a layer of a photoluminescent composition that contains photoluminescent phosphorescent materials and optionally photoluminescent fluorescent materials. The photoluminescent layer may be in the form of a sheath either fully or partially surrounding the core or in certain configurations the photoluminescent layer may be in the form of a film construction covering the core. The layer may also be in the form of a sleeve that covers the fiber. The photoluminescent coating is activated or excited using naturally occurring illumination, such as direct or diffuse sunlight as well as on cloudy days, in addition to artificial sources such as metal halide lamps. Some of the emission from the photoluminescent coating is directed into the optical fiber core and transmitted down the length of the core. With the use of high luminous intensity and persistent photoluminescent phosphorescent compositions, such as those described below, emission from the fiber occurs both during the daytime and at nighttime when the activation source has been removed.

Using a base optical fiber that contains fluorescent materials can enhance the color emitted from the photoluminescent layer by absorbing some of the emissive radiation from the photoluminescent layer and reemitting radiation at a different electromagnetic wavelength. This process may be useful to generate different reticle colors when used in optical sighting devices, as described below.

Since the emission from the photoluminescent coating is omni-directional, not all the light will be directed into the fiber, some will be directed outwardly. Depending on the intensity of the emission, observation may occur long distances from the optical fiber. In this regard a casual observer may readily see the emission particularly during the nighttime when the photoluminescent fiber will appear to glow, thus potentially endangering the gun sight operator when used in a combat situation.

To overcome this problem, a second, emission-blocking composition is applied onto the photoluminescent coating and any exposed portion of the base optical fiber. The second composition is composed of materials that allow electromagnetic radiation to pass through the layer to activate or excite the photoluminescent coating while, at the same time, preventing emissive radiation from the photoluminescent coating to pass back through the second coating. In this manner the photoluminescence can pass into the base optical fiber and be transmitted laterally down the fiber core to the reticle, but will not be seen by an external observer.

Phosphorescent materials suitable for the photoluminescent coatings are the well known metal sulfide phosphors such as are described in U.S. Pat. No. 3,595,804 and metal sulfides that are co-activated with rare earth elements such as those describe in U.S. Pat. No. 3,957,678. Phosphors that are higher in luminous intensity and longer in luminous persistence than the metal sulfide pigments that are also suitable for the present invention include compositions comprising a host material that is generally an alkaline earth aluminate, or an alkaline earth silicate. The host materials generally comprise Europium as an activator and often comprise one or more co-activators such as elements of the Lanthanide series (e.g. lanthanum, cerium, praseodymium, neodymium, samarium, gadolinium, terbium, dysprosium, holmium, erbium, thulium, ytterbium, and lutetium), tin, manganese, yttrium, or bismuth. Examples of such photoluminescent phosphors useful in the current invention are described in U.S. Pat. Nos. 5,424,006, 6,117,362, and 6,267,911B1.

Phosphors that can be used in this invention also include those in which a portion of the Al³⁺ in the host matrix is replaced with divalent ions such as Mg²⁺ or Zn²⁺ and those in which the alkaline earth metal ion (M²⁺) is replaced with a monovalent alkali metal ion such as Li⁺, Na⁺.K⁺, Cs⁺ or Rb⁺. Examples of such phosphors are described in U.S. Pat. No. 6,117,362. & U.S. Pat. No. 6,267,911B1.

As can be appreciated, many other phosphors are useful to the current invention. Such useful phosphors are described in Yen and Weber, Inorganic phosphors: compositions, preparation and optical properties, CRC Press, 2004

While the phosphorescent materials each have their own specific emission spectrum, there may be a desire to obtain a different emission color to give a desired reticle color. This can be accomplished by adjusting the composition to include selected fluorescent materials in the photoluminescent layer or in the base optical fiber or in both.

For the case wherein photoluminescent phosphorescent materials are admixed with selected photoluminescent fluorescent materials, the materials are selected such that the emission from the phosphorescent materials can be absorbed by a first selected fluorescent material which subsequently emits radiation that exhibits a downward Stokes shift to energy lower than the energy that was absorbed. The emission energy from the first fluorescent material can be absorbed by a second fluorescent material selected for its ability to absorb such radiation. The second fluorescent material will exhibit a downward Stokes shift to energy lower than the energy emitted from the first fluorescent material. Additional selected fluorescent materials can be chosen to further exhibit Stokes shifts until a selected emission is achieved. Generally, a Stokes shift for a single phosphorescent or fluorescent material ranges from 20 to 100 nm. In order to produce longer Stokes shifts, multiple fluorescent materials can be used to produce a cascading Stokes shift. A cascading Stokes shift is produced by successive absorptions of the emission of one of the photoluminescent materials by another of the photoluminescent fluorescent materials and re-emission at a longer wavelength.

Selected photoluminescent fluorescent materials useful in the current invention include photoluminescent fluorescent materials that absorb and emit in the visible region of the electromagnetic spectrum. For example, photoluminescent fluorescent materials that absorb and emit in the visible include, for example, coumarins such as coumarin 4, coumarin 6, and coumarin 337; rhodamines such as rhodamine 6G, rhodamine B, rhodamine 101, rhodamine 19, rhodamine 110, and sulfarhodamine B; phenoxazones including Nile red and cresyl violet; styryls; carbostyryls; stilbenes; oxazines; cyanine dyes; pyrromethene dyes; perylene dyes and fluorescein dyes.

It should be emphasized that the phosphorescent materials are carefully selected so that they absorb and emit electromagnetic energies when charged or activated by electromagnetic radiation. The fluorescent materials are carefully selected so that they absorb the emission from the phosphorescent materials and emit energy that is absorbed by another carefully selected fluorescent material which then emits radiation. This selection process is continued until a desired emission color is achieved. The selection of the phosphorescent and fluorescent materials can be manipulated to provide a full spectrum of reticle colors.

The base optical fiber may include fluorescent materials in its composition. These materials can be excited by radiation emitted from the photoluminescent coating and can subsequently emit light in a specifically chosen wavelength. This emitted light is used to illuminate the reticle. The reticle color may be chosen, for example, to be red, orange or yellow. Fluorescent materials in these base optical fibers are therefore selected to emit in the selected wavelength. Thus, in order to achieve a desired color intensity, the phosphorescent and fluorescent materials are selected so that the emission from the photoluminescent phosphorescent materials overlaps with the absorbance of the photoluminescent fluorescent materials, and the final desired sighting color is the emission from the selected photoluminescent fluorescent materials.

A second composition is applied to the photoluminescent coating and any exposed portion of the base optical fiber so as to prevent any stray light or emission from emanating from the sight from being seen. This is most essential during covert operations, such as, for example, military operations. Materials suitable for the second composition are chosen to allow through the maximum amount of radiation that activates the photoluminescent coating while at the same time to block any light that is emitted from the photoluminescent coating. Typical phosphors in the photoluminescent coating are activated by ultraviolet light and emit visible light. Suitable materials are visible light absorbing pigments and dyes. It should be emphasized that the materials of the second composition should be selected such that they have minimal impact on the excitation spectrum of the phosphorescent materials beneath and furthermore have maximum absorption of the emission coming from the photoluminescent layer.

The core optical fiber, whether clear or containing with fluorescent materials, can be coated with the photoluminescent material by a number of method including, brushing, spraying, dip-coating, transfer-coating, roller coating, curtain-coating or other methods will known in the art. The fiber may be extruded using well-known fiber extrusion processes. There needs to be enough photoluminescent material covering the core optical fiber to provide enough light to be generated to illuminate a sighting reticle during the nighttime and before dawn. This will depend on the thickness of the photoluminescent coating, the amount of surface area of the coating that will be exposed to activating radiation, the amount of photoluminescent materials in n the composition. Thus a composition that is highly concentrated with photoluminescent materials can be coated thinly.

The second composition can be applied using the same methods as the photoluminescent coating or differently. It can be co-extruded along with the core optical fiber or it may be separately extruded into a sleeve that is placed over the core optical fiber. It should be emphasized that any portion of the photoluminescent coating, or any part of uncoated core optical fiber, that is exposed to potential viewing by the outside needs to be covered with the second composition.

The optical fiber can be embedded in a holder, so that only a portion of the base optical fiber is exposed to ambient activation radiation. The holder may be, for example, a rectangular block, a cylinder curt lengthwise or other supporting means. This allows the photoluminescent optical fiber to be handled more securely and be placed into a sighting device with improved accuracy. In this case only the exposed portion of the base optical fiber needs to be coated with the photoluminescent composition as is true of the second, blocking composition.

Emission from the uncovered terminal end of the inventive photoluminescent fiber may be further transmitted by connecting the uncovered terminal end to an uncoated optical fiber. A connection between the photoluminescent optical fiber and the uncoated optical fiber may be made with optical adhesives or optical interconnects, both of which are well known in the art, or may simple be positioned end to end to transmit the light. The uncoated fiber transmits the emission to illuminate a reticle that is used for sighting.

It is assumed that the uncoated optical fiber transmits light unseen through the body of the device, that is, no transmitted light can be seen by the casual observer. In a case where there is extraneous light coming from the transmitting, non-photoluminescent fiber, the second blocking coating of the current invention prevents any light from getting out and being observed, especially at night. In sighting mechanisms wherein there are secondary reticle illumination sources, stray light may travel back along the optical fiber to the exposed optical fiber. The second, blocking layer of the current invention also prevents this light from being observed.

The base optical fiber containing fluorescent materials may extend beyond the photoluminescent and second layers into the body of the sighting device. The fiber can then be activated by artificial sources other than photoluminescent sources, such as, for example LED sources, tritium radioluminescent sources, chemiluminescent sources and other non-photoluminescent, artificial, sources. The final desire color or the reticle is independent from the color of the artificial non-photoluminescent sources because the fiber is formulated to absorb the emission from the source and emit, either singly or through a combination of absorption and emission processes to create the final desired color. In this manner the inventive fiber can be activated by photoluminescence or by back-up systems typically present in modern sighting devices.

Devices made from the photoluminescent fibers of the current invention include sights for handguns, rifles, grenade launchers and other weapons where sighting is desired, cameras, distance finding devices, binoculars, telescopes or other device in which a targeting and/or ranging mechanism is desired. Larger guns such as heavy artillery are also suitable for using the inventive sighting devices.

### Example 1

### Photoluminescent Composition that Contains Fluorescent Materials

Into 31.26 g of toluene was admixed 20.84 g of NeoCryl® B-805 (an acrylic resin from DSM NeoResins®) with stirring. 0.48 g of TEGO® Wet 270, 0.31 g of TEGO® Airex 900 and 3.33 g of TEGO® Disperse 655 (all from Degussa GmbH) was added with stirring. Then 0.004 g of rhodamine 110, 0.002 g of rhodamine 19, 0.002 g of rhodamine 6G (each from BASF) and 0.002 g of 3,3′-diethylthiacarbocyanine iodide were added and mixed until dissolved. 41.69 g of H-13, green phosphor (from Capricorn Specialty Chemicals) was then added with mixing. 2.08 g of BYK® 430 (from BYK-Chemie) was then added with mixing. This composition provides a bright red-orange emission.

Blocking composition used as the second coating that allows activating radiation to pass through and activate the photoluminescent coating beneath while blocking any emissive radiation from passing back through to the outside.

46.87 g of Hauthane L-3074 and 46.87 g of Hauthane L-3058 (both aqueous urethanes from C. L. Hauthaway Corp) are admixed with 1.90 g of TEGO® Wet 270 (from Degussa GmbH) and 2.86 g of Tinuvin® 1130 (from Ciba Specialty Chemicals). To this admix are added 0.60 g of ORCOBRITE™ Pigment Violet 4BN, 0.30 g of ORCOBRITE™ Pigment Blue 3G HLF and 0.60 g of ORCOBRITE™ Pigment Yellow HLF (all three from Organic Dyestuffs Corp). Mixing is continued until uniform.

### Fiber Construction

A 1.5 mm glass optical fiber is dip-coated with the photoluminescent composition up to but not including the terminal end of the fiber and allowed to hang in a 35 deg C. oven for 30 min. The fiber is then dip-coated in the blocking composition again up to but not including the terminal end of the fiber and allowed to hang in a 50 deg C. oven for 2 hours until dry.

The fiber is placed in a sighting mechanism such that the uncoated terminal end is inserted into the body of the mechanism and coupled to the secondary fiber that transfers the emission to the reticle. The sighting mechanism is exposed to ambient light wherein the photoluminescent optical fiber is charged up. The sighting mechanism is taken into a room with low light and used to line up a bright red reticle with a lowly lit target. The sighting mechanism was kept in the lowly lit room for 10 hrs after which the sighting reticle could readily be seen and used for targeting. The photoluminescent optical fiber could not be seen at anytime during the sighting exercise.

### Example 2

Example 1 was repeated but with the following 2 exceptions:
a) a 1.5 polymethyl methacrylate optical fiber containing 0.1% by weight of a red fluorescent dye was used in place of the glass optical fiber
b) the photoluminescent composition use did not contain LUMOGEN® F305

The exercise was repeated and the reticle was illuminated with red light. Again no light could be seen coming from the photoluminescent optical fiber.

We claim:

1. A photoluminescent optical fiber for illuminating a reticle in a sighting device for day and night sighting comprising:
a) A base optical fiber,
b) a photoluminescent layer comprising one or more selected photoluminescent phosphorescent materials, wherein the materials are selected to provide a final desired sighting color, and wherein the layer covers at least a portion of the base optical fiber and,
c) a second layer covering at least all parts of the photoluminescent layer, comprising selected materials that allow radiation which charges the underlying photoluminescent materials to pass through the second layer as well as to block emission from the underlying photoluminescent materials from passing back through the second layer.

2. The photoluminescent optical fiber of claim 1, wherein the photoluminescent layer further comprises one or more fluorescent materials, and wherein the one or more photoluminescent phosphorescent materials are selected so that they absorb and emit electromagnetic energies when charged or activated by electromagnetic radiation, and wherein the one or more photoluminescent fluorescent materials are selected so that they absorb the emission from the one or more photoluminescent materials and emit electromagnetic energies to give a selected emission signature of a final desired sighting color, the photoluminescent materials being selected so that the emission of one of the photoluminescent materials overlaps with the absorbance of another of the photoluminescent materials, wherein the selected emission signature is the emission from one or more of the selected photoluminescent fluorescent materials, such emission being essentially unabsorbed by any of the other photoluminescent materials.

3. A photoluminescent optical fiber for illuminating a reticle in a sighting device for day and night sighting comprising:
a) a base optical fiber comprising one or more photoluminescent fluorescent materials,
b) a photoluminescent layer comprising one or more selected photoluminescent phosphorescent materials, wherein the layer covers the base optical fiber, and
c) a second layer covering the photoluminescent layer, comprising selected materials that allow radiation which charges the underlying photoluminescent materials to pass through the second layer as well as to block emission from the underlying photoluminescent materials from passing back through the second layer.
wherein the photoluminescent fluorescent materials in the base optical fiber and the photoluminescent phosphorescent materials in the photoluminescent layer are selected so that they absorb and emit electromagnetic energies when charged or activated by electromagnetic radiation, and wherein the one or more photoluminescent fluorescent materials are selected so that they absorb the emission from the one or more photoluminescent materials and emit electromagnetic energies to give a selected emission signature of a final desired sighting color, the photoluminescent materials being selected so that the emission of one of the photoluminescent materials overlaps with the absorbance of another of the photoluminescent materials, wherein the selected emission signature is the emission from one or more of the selected photoluminescent fluorescent materials, such emission being essentially unabsorbed by any of the other photoluminescent materials.

4. The photoluminescent fiber of any one of claims 1-3, wherein the base fiber is comprised of a core and a cladding layer whose refractive index is lower than the refractive index of the core.

5. A sighting device for day and night sighting comprising a photoluminescent optical fiber comprising:
a) A base optical fiber,
b) a photoluminescent layer comprising one or more selected phosphorescent materials, wherein the materials are selected to provide a final desired sighting color, and wherein the layer covers at least a portion of the base optical fiber and,
c) a second layer covering at least all parts of the photoluminescent layer, comprising selected materials that allow radiation which charges the underlying photoluminescent materials to pass through the second layer as well as to block emission from the underlying photoluminescent materials from passing back through the second layer.

6. The sighting device of claim 5, wherein the photoluminescent layer further comprises one or more fluorescent materials, and wherein the one or more photoluminescent phosphorescent materials are selected so that they absorb and emit electromagnetic energies when charged or activated by electromagnetic radiation, and wherein the one or more photoluminescent fluorescent materials are selected so that they absorb the emission from the one or more photoluminescent materials and emit electromagnetic energies to give a selected emission signature of a final desired sighting color, the photoluminescent materials being selected so that the emission of one of the photoluminescent materials overlaps with the absorbance of another of the photoluminescent materials, wherein the selected emission signature is the emission from one or more of the selected photoluminescent fluorescent materials, such emission being essentially unabsorbed by any of the other photoluminescent materials.

7. A sighting device for day and night sighting comprising a photoluminescent optical fiber comprising:
a) a base optical fiber comprising one or more photoluminescent fluorescent materials,
b) a photoluminescent layer comprising one or more selected photoluminescent phosphorescent materials, wherein the layer covers the base optical fiber, and
c) a second layer covering the photoluminescent layer, comprising selected materials that allow radiation which charges the underlying photoluminescent materials to pass through the second layer as well as to block emission from the underlying photoluminescent materials from passing back through the second layer.
wherein the photoluminescent fluorescent materials in the base optical fiber and the photoluminescent phosphorescent materials in the photoluminescent layer are selected so that they absorb and emit electromagnetic energies when charged or activated by electromagnetic radiation, and wherein the one or more photoluminescent fluorescent materials are selected so that they absorb the emission from the one or more photoluminescent materials and emit electromagnetic energies to give a selected emission signature of a final desired sighting color, the photoluminescent materials being selected so that the emission of one of the photoluminescent materials overlaps with the absorbance of another of the photoluminescent materials, wherein the selected emission signature is the emission from one or more of the selected photoluminescent fluorescent materials, such emission being essentially unabsorbed by any of the other photoluminescent materials.

8. The sighting device of any one of claims 5-7, wherein the base fiber is comprised of a core and a cladding layer whose refractive index is lower than the refractive index of the core.

9. A method of covertly sighting an object comprising operating the sighting device of claim 8.

10. A sighting device for day and night sighting comprising a photoluminescent optical fiber comprising:
a) a holder mechanism,
b) a base optical fiber,
c) a photoluminescent layer comprising one or more selected phosphorescent materials, wherein the materials are selected to provide a final desired sighting color, and wherein the layer covers at least a portion of the base optical fiber and,
d) a second layer covering at least all parts of the photoluminescent layer, comprising selected materials that allow radiation which charges the underlying photoluminescent materials to pass through the second layer as well as to block emission from the underlying photoluminescent materials from passing back through the second layer.

11. The sighting device of claim 10, wherein the photoluminescent layer further comprises one or more fluorescent materials, and wherein the one or more photoluminescent phosphorescent materials are selected so that they absorb and emit electromagnetic energies when charged or activated by electromagnetic radiation, and wherein the one or more photoluminescent fluorescent materials are selected so that they absorb the emission from the one or more photoluminescent materials and emit electromagnetic energies to give a selected emission signature of a final desired sighting color, the photoluminescent materials being selected so that the emission of one of the photoluminescent materials overlaps with the absorbance of another of the photoluminescent materials, wherein the selected emission signature is the emission from one or more of the selected photoluminescent fluorescent materials, such emission being essentially unabsorbed by any of the other photoluminescent materials.

12. A sighting device for day and night sighting comprising a photoluminescent optical fiber comprising:
a) a holder mechanism,
b) a base optical fiber comprising one or more photoluminescent fluorescent materials,
c) a photoluminescent layer comprising one or more selected photoluminescent phosphorescent materials, wherein the layer covers the base optical fiber, and
d) a second layer covering the photoluminescent layer, comprising selected materials that allow radiation which charges the underlying photoluminescent materials to pass through the second layer as well as to block emission from the underlying photoluminescent materials from passing back through the second layer.
wherein the photoluminescent fluorescent materials in the base optical fiber and the photoluminescent phosphorescent materials in the photoluminescent layer are selected so that they absorb and emit electromagnetic energies when charged or activated by electromagnetic radiation, and wherein the one or more photoluminescent fluorescent materials are selected so that they absorb the emission from the one or more photoluminescent materials and emit electromagnetic energies to give a selected emission signature of a final desired sighting color, the photoluminescent materials being selected so that the emission of one of the photoluminescent materials overlaps with the absorbance of another of the photoluminescent materials, wherein the selected emission signature is the emission from one or more of the selected photoluminescent fluorescent materials, such emission being essentially unabsorbed by any of the other photoluminescent materials.

13. The sighting device of any one of claims 10-12, wherein the base fiber is comprised of a core and a cladding layer whose refractive index is lower than the refractive index of the core.

14. The sighting device of claim 13, wherein the holder is a solid polygon or is cylindrical and the base optical fiber is embedded partially in the holder, is fitted to the holder by way of an impression in the holder or attached to the holder with an adhesive.

15. A method of covertly sighting an object comprising operating the sighting device of claim 14.
